(19) United States
(12) Patent Application Publication
(10) Pub. No.: US 2026/0116271 A1
(43) Pub. Date: Apr. 30, 2026

(54) BACK FRAME

(71) Applicant: TOYOTA BOSHOKU KABUSHIKI KAISHA, Aichi (JP)

(72) Inventors: Keisuke YAMAMOTO, Toyota-shi (JP); Ririka AKITA, Toyota-shi (JP)

(73) Assignee: TOYOTA BOSHOKU KABUSHIKI KAISHA, Aichi (JP)

(21) Appl. No.: 19/365,748

(22) Filed: Oct. 22, 2025

(30) Foreign Application Priority Data
Oct. 28, 2024 (JP) 2024-189147

(51) Int. Cl. B60N 2/20; B60N 2/68

(52) U.S. Cl. CPC B60N 2/20; B60N 2/682

(57) ABSTRACT

In a back frame used in a seatback of a vehicle seat, upper end portions of first and second side frames extending in up-down directions are coupled to each other by a first coupling member, lower end portions of first and second side frames are coupled to each other by a second coupling member, a recliner is fixed at least to the lower end portion of the first side frame, an imaginary shape that is defined by connecting joined areas between the second coupling member and the first side frame and that is projected onto an imaginary plane orthogonal to the seat-width directions is a polygon, and a hinge center of the recliner projected onto the imaginary plane is located inside the polygon.

### CROSS-REFERENCE TO RELATED APPLICATIONS

This application claims the benefit of Japanese Patent Application No. 2024-189147 filed on October 28, 2024 with the Japan Patent Office, and the entire disclosure of which is incorporated herein by reference.

### BACKGROUND

The present disclosure relates to a back frame to be used in a seatback of a vehicle seat.

For example, a back frame disclosed in Japanese Unexamined Patent Application Publication No. 2008-194289 comprises a round pipe formed into a U-shape by bending, a pipe extending in seat-width directions and coupling portions of the round pipe with each other, the portions extending in up-down directions, and the like.

### SUMMARY

The present disclosure discloses an example of a back frame capable of inhibiting deformation of a part of the back frame extending in seat up-down directions (hereinafter, referred to as a “side frame”) due to an external force acting on the part to twist the same.

What is meant by the “deformation of the side frame to twist the same” is, for example, torsional deformation centered around an imaginary axis that passes through a centroid of a cross-section of the side frame and extends in a longitudinal direction of the side frame.

It is desirable that a back frame used in a seatback of a vehicle seat according to an aspect of the present disclosure comprises at least one of the following constituent elements, for example.

Specifically, the constituent elements include: a first side frame that is arranged on one end side in seat-width directions and that extends in up-down directions; a second side frame that is arranged on the other end side in the seat-width directions and that extends in the up-down directions; a first coupling member extending in the seat-width directions and coupling an upper end portion of the first side frame to an upper end portion of the second side frame; a recliner constituting a hinge mechanism configured to change and maintain angles of the first side frame and the second side frame, the recliner being fixed at least to a lower end portion of the first side frame; and a second coupling member extending in the seat-width directions and coupling the lower end portion of the first side frame to a lower end portion of the second side frame.

The second coupling member is joined to the first side frame at a front portion and a rear portion, between which a hinge center of the recliner is located. In addition, an imaginary shape that is defined by connecting joined areas between the second coupling member and the first side frame and that is projected onto an imaginary plane orthogonal to the seat-width directions is a polygon, and the hinge center projected onto the imaginary plane is located inside the polygon projected onto the imaginary plane.

In the configuration as described above, in the back frame, when an external force acts on the first side frame to twist the first side frame, the second coupling member receives torsion torque generated in the first side frame as a tensile force and a compressive force as the second coupling member and the first side frame are joined together.

Torsional deformation is shear deformation, and in general, tensile deformation and compressive deformation can be suppressed more effectively than shear deformation. Therefore, the above configuration can inhibit large torsional deformation of the first side frame more effectively than in a configuration where the torsional deformation is resisted solely by the shear stress generated in the first side frame.

The back frame may be configured as below, for example.

Specifically, it is desirable that a longitudinally intermediate portion of the second coupling member has a substantially C-shaped cross-section with an open upper side. Furthermore, it is desirable that a joint length of a joined area located rearward of the hinge center among the joined areas is longer than a joint length of a joined area located forward of the hinge center among the joined areas.

### BRIEF DESCRIPTION OF THE DRAWINGS

Example embodiments of the present disclosure will be described hereinafter with reference to the accompanying drawings, in which:

FIG. 1 is a diagram showing a back frame according to a first embodiment;

FIG. 2 is a diagram showing an upper part of the back frame according to the first embodiment;

FIG. 3 is a diagram showing the back frame according to the first embodiment;

FIG. 4 is a diagram showing a lower beam according to the first embodiment;

FIG. 5 is a diagram showing a joined structure of the lower beam and a first side frame;

FIG. 6 is a diagram showing the joined structure of the lower beam and the first side frame; and

FIG. 7 is a diagram showing the joined structure of the lower beam and the first side frame.

### DETAILED DESCRIPTION OF EXEMPLARY EMBODIMENTS

Embodiments below show examples of embodiments belonging to the technical scope of the present disclosure. Invention-specifying matters and so on recited in the appended claims are not limited by specific configurations, structures, and the like indicated in the below-described embodiments.

The present embodiment is an example in which a back frame according to the present disclosure is applied to a seat to be installed in a vehicle, such as an automobile (hereinafter, referred to as a “vehicle seat”). Arrows indicating directions and diagonal lines shown in the drawings are provided for the purpose of easier understanding of mutual relationships between the drawings, shapes of members or portions and the like.

Thus, a direction of the back frame is not limited by the directions shown in the drawings. The directions shown in the drawings are based on a state where the vehicle seat according to the present embodiment is mounted on an automobile. The drawings with diagonal lines provided thereon are not necessarily cross-sectional views.

A member or portion described at least with a reference numeral is at least one in number except in a case of being accompanied by restrictive words such as “only one”. In other words, the member or portion may be two or more in number in a case of not being accompanied by the restrictive words such as “only one”. The back frame disclosed in the present disclosure comprises at least one of constituent elements such as a member or a portion described at least with a reference numeral or a structural part illustrated.

### First Embodiment

### 1. Overview of Back Frame

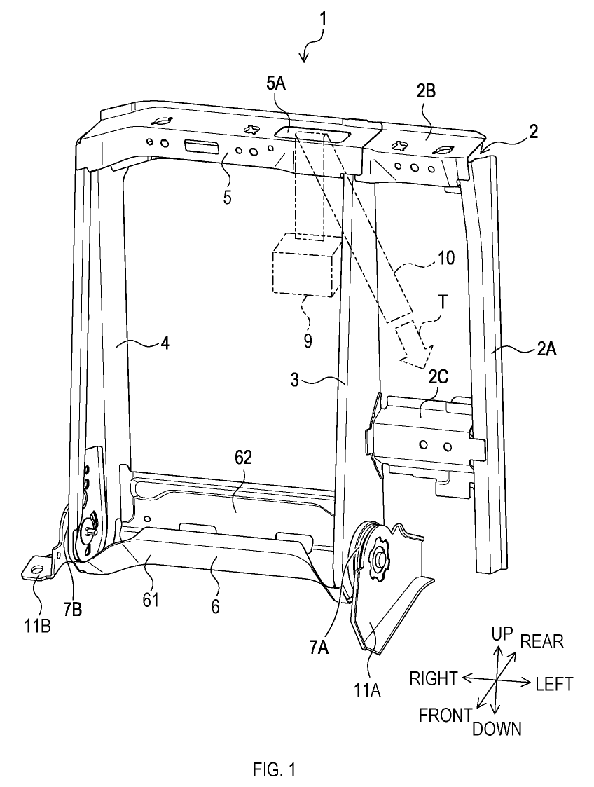

As illustrated in FIG. 1, a back frame 1 according to the present embodiment is one example of a frame that is used in a seatback of a rear seat of a vehicle. Specifically, the back frame 1 is used in a right-side seat of the vehicle rear seat designed for three occupants.

The seatback supports an occupant’s back. The back frame 1 forms a framework of the seatback. In the present embodiment, a frame 2 for a middle seat is coupled to the back frame 1.

The frame 2 for the middle seat includes a tower frame 2A, a first coupling frame 2B, a second coupling frame 2C, and the like. The tower frame 2A is a high-strength member extending in up-down directions. The first coupling frame 2B and the second coupling frame 2C are high-strength members to couple the tower frame 2A to the back frame 1.

### 2. Details of Back Frame

### 2.1 Configuration of Back Frame

The back frame 1 comprises at least a first side frame 3, a second side frame 4, an upper beam 5, a lower beam 6, a first recliner 7A, a second recliner 7B, a back panel (not shown), and the like.

The first side frame 3 is a high-strength member that is arranged on one end side of the vehicle seat in seat-width directions (on a left end side in the present embodiment) and that extends in the up-down directions. The second side frame 4 is a high-strength member that is arranged on the other end side of the vehicle seat in the seat-width directions (on a right end side in the present embodiment) and that extends in the up-down directions.

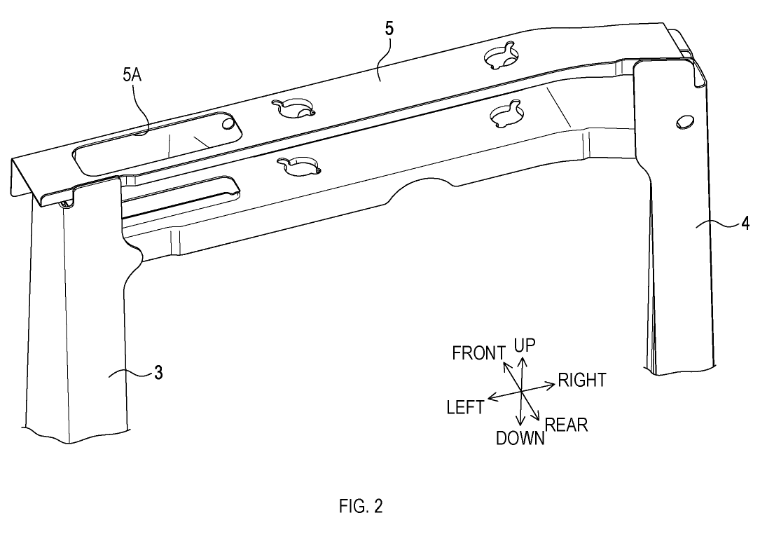

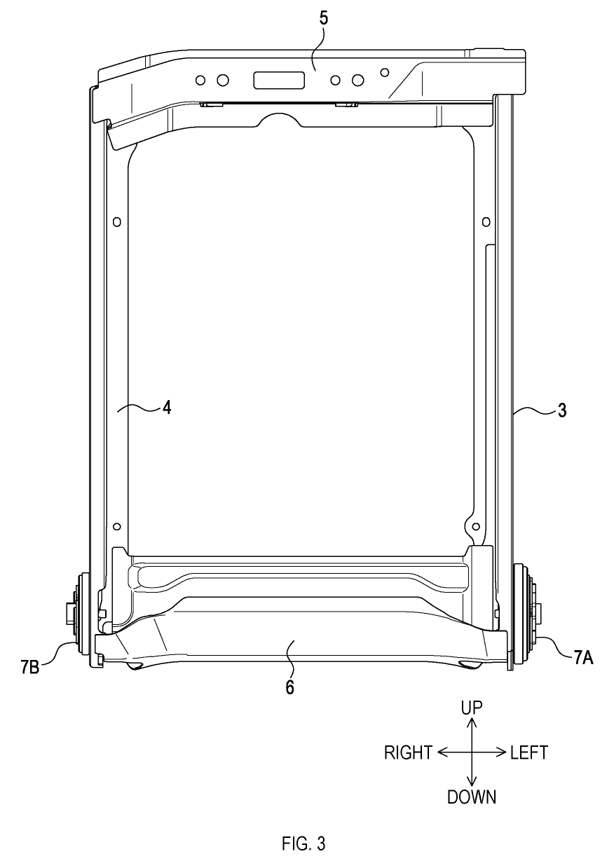

The upper beam 5 is one example of a first coupling member and, as illustrated in FIG. 3, is an upper panel extending in the seat-width directions and coupling an upper end portion of the first side frame 3 to an upper end portion of the second side frame 4. The upper beam 5 is formed to have a substantially U-shaped or C-shaped cross-section with an open rear side (see FIG. 2).

As illustrated in FIG. 3, the lower beam 6 is one example of a second coupling member, which is a lower panel extending in the seat-width directions and coupling a lower end portion of the first side frame 3 to a lower end portion of the second side frame 4. The first side frame 3, the second side frame 4, the upper beam 5, and the lower beam 6 form a frame body with a rectangular frame shape.

The back panel (not shown) is a plate-shaped member that is disposed rearward of the frame body and that covers an entire rear surface of the frame body. The back panel according to the present embodiment covers a rear surface of the frame 2 for the middle seat, in addition to the rear surface of the frame body.

As illustrated in FIG. 1, a retractor 9 is fixed to a portion of the back panel below the upper beam 5. The retractor 9 is a device that winds up a seat belt 10. The upper beam 5 is provided with a belt receiver 5A.

The belt receiver 5A is a part of the upper beam 5 where a through hole is provided to allow the seat belt 10 to pass through. When a tensile force T is applied to the seat belt 10, the belt receiver 5A receives the tensile force T. In other words, the tensile force T is input to the frame body via the upper beam 5.

The first recliner 7A and the second recliner 7B are devices that each constitute a hinge mechanism to change and maintain an angle of the back frame 1. Specifically, the first recliner 7A is fixed by welding at one side to the lower end portion of the first side frame 3 and fixed at the other side to the vehicle via a bracket 11A.

The second recliner 7B is fixed at one side to the vehicle via a bracket 11B and fixed by welding at the other side to the lower end portion of the second side frame 4. In the present embodiment, the “one side” refers to the right side, while the “other side” refers to the left side.

### 2.2 Detailed Structure of Lower Beam

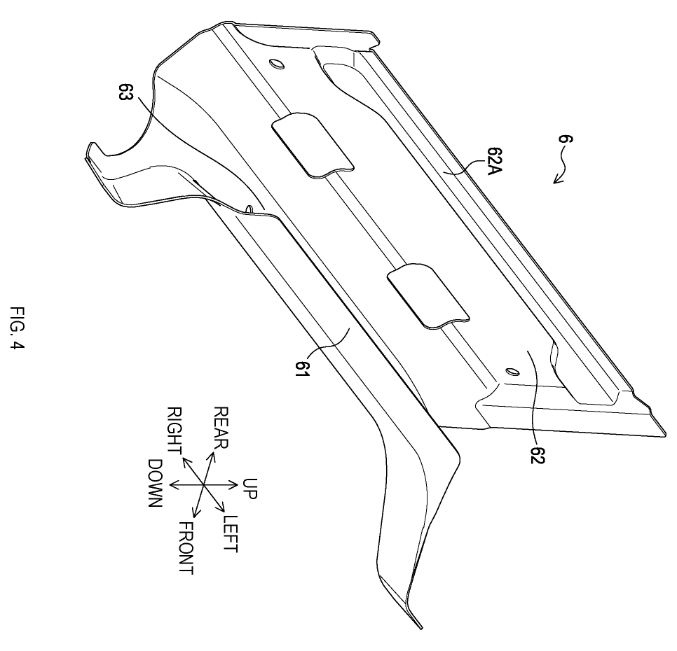

As illustrated in FIG. 4, the lower beam 6 includes a front panel 61, a rear panel 62, a bottom panel 63, and the like. The front panel 61, the rear panel 62, and the bottom panel 63 are an integrated part manufactured from a single steel sheet using press forming.

A longitudinally intermediate portion of the lower beam 6 has a substantially C-shaped cross-section with an open upper side. The longitudinally intermediate portion of the lower beam 6 refers to a predetermined area including a center of the lower beam 6 in a longitudinal direction (i.e., a midpoint in the longitudinal direction).

A longitudinally intermediate portion of the front panel 61 has a shape recessed rearward so as to be positioned rearward relative to both one end and the other end of the front panel 61 in a longitudinal direction. The recessed shape is provided to avoid interference with the seated occupant’s buttocks.

In the rear panel 62, a beam 62A is provided that extends in the seat-width directions. The beam 62A is formed by a protrusion that protrudes in seat front-rear directions and extends in the seat-width directions. Thus, the beam 62A functions as a reinforcer that improves flexural rigidity of the rear panel 62.

One end portion of the lower beam 6 in the longitudinal direction is joined to the lower end portion of the first side frame 3 by welding. The other end portion of the lower beam 6 in the longitudinal direction is joined to the lower end portion of the second side frame 4 by welding. The lower beam 6 according to the present embodiment is joined to each of the first side frame 3 and the second side frame 4 by laser welding.

### 2.3 Joined Structure between Lower Beam and Side Frame

The following description is directed to a joined structure between the lower beam 6 and the first side frame 3. In the present embodiment, the joined structure between the lower beam 6 and the first side frame 3, and a joined structure between the lower beam 6 and the second side frame 4 are the same. Thus, description of the joined structure between the lower beam 6 and the second side frame 4 will be omitted.

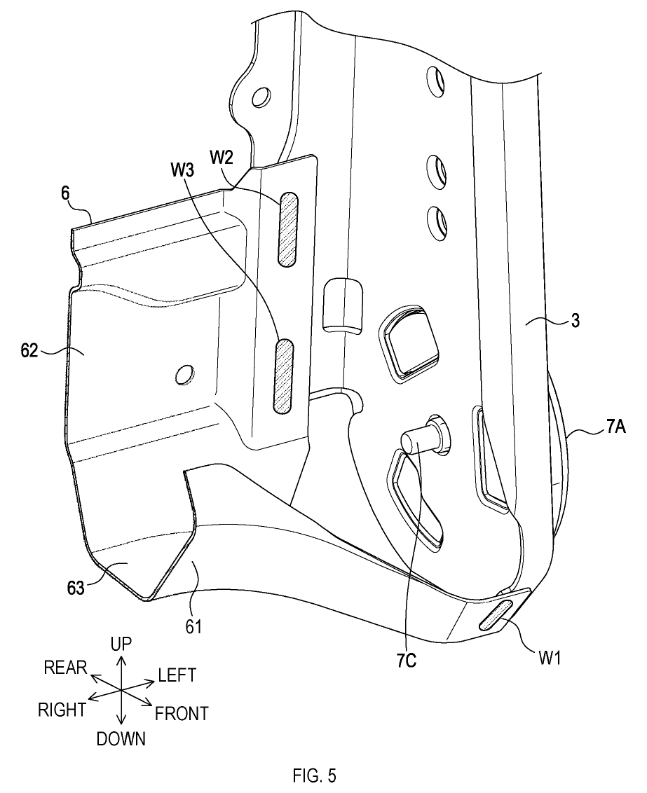

As illustrated in FIG. 5, the lower beam 6 is provided with a first joined portion W1, a second joined portion W2, a third joined portion W3, and the like. The first joined portion W1 is a joined area located on a front side with respect to a hinge center 7C of the recliner 7A.

The second joined portion W2 and the third joined portion W3 are joined areas located on a rear side with respect to the hinge center 7C. A joint length of the rear joined areas located rearward of the hinge center 7C is longer than a joint length of the front joined area located forward of the hinge center 7C.

The joint length of the joined areas located rearward is the sum of the joint length of the second joined portion W2 and the joint length of the third joined portion W3. The joint length of the joined area located forward is the joint length of the first joined portion W1.

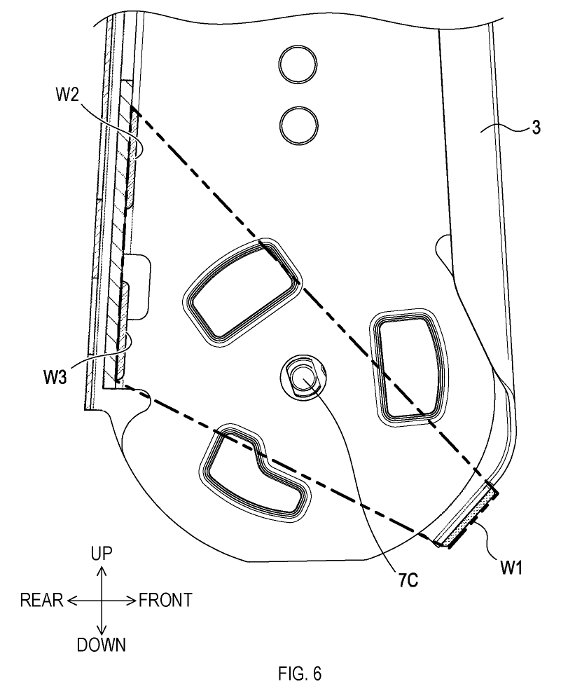

An imaginary shape that is defined by connecting the first joined portion W1 through the third joined portion W3 and that is projected onto an imaginary plane orthogonal to the seat-width directions is a polygon (quadrilateral in the present embodiment), as represented by a thick chain double-dashed line in FIG. 6. The hinge center 7C projected onto the imaginary plane is located inside the polygon projected onto the imaginary plane (i.e., the shape as represented by the thick chain double-dashed line).

The imaginary shape defined by connecting the first joined portion W1 through the third joined portion W3, namely, the imaginary shape defined by connecting the joined areas, refers to a shape formed when the ends of the joined portions are connected by an imaginary straight line. The ends of the joined areas, namely, the ends of the joined portions refer to ends of contours of the joined portions when viewed macroscopically.

In the present embodiment, laser welding is employed as the joining method. Thus, the ends of the joined areas (i.e., joined portions) refer to, specifically, weld marks by laser welding. Therefore, the ends of the joined portions according to the present embodiment refer to ends of the weld marks.

When the joined areas, namely, the weld marks are curved to macroscopically represent curve lines, the imaginary shape defined by connecting the joined areas is a polygon with round corners. When the welding method is spot welding, a shape represented by an imaginary straight line connecting dot-like joined portions (i.e., weld marks) is the imaginary shape defined by connecting the joined areas.

### 3. Characteristics of Back Frame of the Present Embodiment

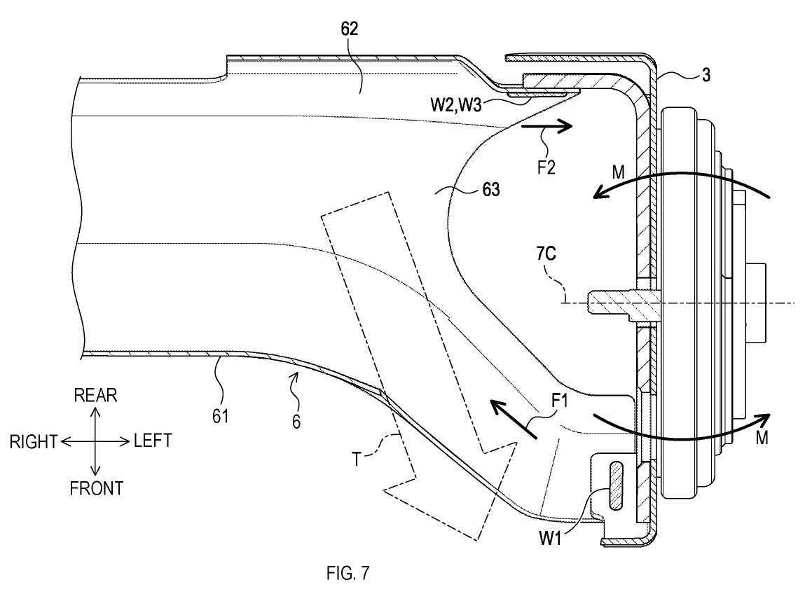

When the tensile force T is applied to the seat belt 10, the back frame 1 receives the tensile force T with the belt receiver 5A. Thus, as illustrated in FIG. 7, a stress is generated in the first side frame 3 to cause a torsional deformation centered around the hinge center 7C to twist the first side frame 3.

In the back frame 1 of the present embodiment, the first joined portion W1 is located at a front portion of the first side frame 3, and the second joined portion W2 and the third joined portion W3 are located at a rear portion of the first side frame 3.

Therefore, in the back frame 1, when a stress is generated in the first side frame 3 to cause a torsional deformation in the first side frame 3 to twist the same, the lower beam 6 receives torsion torque M generated in the first side frame 3 as a tensile force F1 and a compressive force F2, as the lower beam 6 and the first side frame 3 are joined at the first joined portion W1 through the third joined portion W3.

Torsional deformation is shear deformation, and in general, tensile deformation and compressive deformation can be suppressed more effectively than shear deformation. Thus, the present embodiment can inhibit large torsional deformation of the first side frame 3 more effectively than in a configuration where the torsional deformation is resisted solely by shear stress generated in the first side frame 3.

Furthermore, the hinge center 7C projected onto the imaginary plane is located inside the polygon projected onto the imaginary plane (i.e., the shape represented by the thick chain double-dashed line in FIG. 6). This makes it possible to reliably ensure the torsional rigidity around the hinge center 7C.

### Other Embodiments

In the above-described embodiment, the first joined portion W1, the second joined portion W2, and the third joined portion W3 are joined by welding. However, the present disclosure is not limited to this. Specifically, the present disclosure may have a configuration of, for example, bonding the joints using an adhesive agent.

In the above-described embodiment, the back frame 1 comprises the back panel made of metal. However, the present disclosure is not limited to this. Specifically, the present disclosure may be applicable, for example, to a back frame in which the back panel is not used, or to a back frame equipped with a back panel made of resin.

In the above-described embodiment, the retractor 9 is fixed to the back panel made of metal. However, the present disclosure is not limited to this. Specifically, the present disclosure may be applicable, for example, to a configuration that does not include the retractor 9, or to a configuration in which the retractor 9 is fixed to the side frame or the upper beam.

The lower beam 6 of the above-described embodiment is formed to have a substantially C-shaped cross-section with the open upper side. However, the present disclosure is not limited to this. Specifically, the disclosure may be applicable, for example, to a configuration in which the front panel 61 and the rear panel 62 are independent components and the lower beam 6 is formed by the two components 61 and 62.

In the above-described embodiment, the vehicle seat according to the present disclosure is applied to a car. However, application of the present disclosure is not limited to this. As an alternative, the present disclosure may also be applied to, for example, a seat used in vehicles such as railroad vehicles, ships, or aircrafts, and to a stationary seat used in theaters, at home, or in other places.

Moreover, the present disclosure only has to be consistent with the spirit of the disclosure recited in the above-described embodiments, and is not limited to the above-described embodiments. Accordingly, the present disclosure may take a configuration in which at least two embodiments among the above-described embodiments are combined together, or a configuration in which any of the diagrammatically-shown constituent elements or the constituent elements described with reference numerals in the above-described embodiments are omitted.

What is claimed is:

1. A back frame used in a seatback of a vehicle seat, the back frame comprising:
a first side frame that is arranged on one end side of the vehicle seat in seat-width directions and that extends in up-down directions;
a second side frame that is arranged on the other end side of the vehicle seat in the seat-width directions and that extends in the up-down directions;
a first coupling member extending in the seat-width directions and coupling an upper end portion of the first side frame to an upper end portion of the second side frame;
a recliner constituting a hinge mechanism configured to change and maintain angles of the first side frame and the second side frame, the recliner being fixed at least to a lower end portion of the first side frame; and
a second coupling member extending in the seat-width directions and coupling the lower end portion of the first side frame to a lower end portion of the second side frame,
wherein the second coupling member is joined to the first side frame at a front portion and a rear portion, between which a hinge center of the recliner is located, and
wherein an imaginary shape that is defined by connecting joined areas between the second coupling member and the first side frame and that is projected onto an imaginary plane orthogonal to the seat-width directions is a polygon, and the hinge center projected onto the imaginary plane is located inside the polygon projected onto the imaginary plane.

2. The back frame according to claim 1,
wherein a longitudinally intermediate portion of the second coupling member has a substantially C-shaped cross-section with an open upper side.

3. The back frame according to claim 1,
wherein a joint length of a joined area located rearward of the hinge center among the joined areas is longer than a joint length of a joined area located forward of the hinge center among the joined areas.

4. The back frame according to claim 2,
wherein a joint length of a joined area located rearward of the hinge center among the joined areas is longer than a joint length of a joined area located forward of the hinge center among the joined areas.
